(19) United States
(12) Patent Application Publication
(10) Pub. No.: US 2017/0178532 A1
(43) Pub. Date: Jun. 22, 2017

(54) Coaching Feedback Adjustment Mechanism

(71) Applicants: Mei Lu, Portland, OR (US); David P. Kuhns, Salem, OR (US); Saurabh Dadu, Tigard, OR (US); Lavinia A. Danielescu, Santa Clara, CA (US); Jessica M. Christian, Redwood City, CA (US); Charles E. Johnson, II, Hillsboro, OR (US); Barrett Kenney, Hillsboro, OR (US); David Gottardo, Roquefort les Pins (FR); Megan Hansen, Portland, OR (US)

(72) Inventors: Mei Lu, Portland, OR (US); David P. Kuhns, Salem, OR (US); Saurabh Dadu, Tigard, OR (US); Lavinia A. Danielescu, Santa Clara, CA (US); Jessica M. Christian, Redwood City, CA (US); Charles E. Johnson, II, Hillsboro, OR (US); Barrett Kenney, Hillsboro, OR (US); David Gottardo, Roquefort les Pins (FR); Megan Hansen, Portland, OR (US)

(21) Appl. No.: 14/977,877

(22) Filed: Dec. 22, 2015

(51) Int. Cl. G09B 19/00; G09B 5/00

(52) U.S. Cl. CPC G09B 19/00; G09B 5/00

(57) ABSTRACT

A method is described to facilitate coaching feedback adjustment. The method includes generating feedback for a user, receiving contextual data at a sensor array, determining a context based on contextual conditions identified from the contextual data, determining an action to be taken based on the identified contextual conditions, determining whether the feedback is appropriate based on the action to be taken and the contextual conditions and playing the feedback upon a determination that the feedback is appropriate.

### FIELD

Embodiments described herein generally relate to wearable computing. More particularly, embodiments relate to sports training based wearable devices.

### BACKGROUND

Real time coaching is an important area of development for various devices implemented for fitness and sport usage. Moreover, real-time coaching applications or devices are designed to provide audio feedback to athletes, or fitness users, for different purposes. For example, real time coaching may be incorporated in applications or devices for running, cycling, swimming, and skiing, and may provide guidance/instructions on actions a user needs to take in order to follow a training plan, to notify a user when a specific event has happened during a workout, to correct a mistake, and provide encouragement or performance feedback.

However, during a workout, a user's ability to hear, digest or follow coaching feedback or advice is often impacted by environmental factors, such as background noise, location, road conditions, as well as a user's internal factors (e.g., physical exhaustion or activities). For runners or cyclists who train on or by a busy road, background noises may temporarily become too loud for them to hear anything from a device or application. For instance, with a big truck going by, or a loud lawn mower working nearby. If all coaching feedback is provided regardless of contexts related to environmental circumstances or user activities, a device or application may provide useless feedback or create annoyance.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a coaching feedback adjustment mechanism at a computing device according to one embodiment.

FIG. 2 illustrates one embodiment of a coaching feedback adjustment mechanism.

FIG. 3 illustrates one embodiment of a contextual engine.

FIG. 4 illustrates one embodiment of a play decision engine.

FIG. 5 is a flow diagram illustrating one embodiment of a process performed by a coaching feedback adjustment mechanism.

FIG. 6 illustrates a computer system suitable for implementing embodiments of the present disclosure.

### DETAILED DESCRIPTION

Embodiments may be embodied in systems, apparatuses, and methods for athletic feedback, as described below. In the description, numerous specific details, such as component and system configurations, may be set forth in order to provide a more thorough understanding of the present invention. In other instances, well-known structures, circuits, and the like have not been shown in detail, to avoid unnecessarily obscuring the present invention.

Embodiments provide for a coaching feedback adjustment mechanism that uses context information related to external environments and user activities to determine a best time to play audio-based coaching feedback for sports activities. In such embodiments, the coaching feedback adjustment mechanism makes necessary adjustments to coaching feedback based on the detected context data. The coaching feedback adjustment mechanism may postpone or cancel a feedback message, to play an alternative message, or adjust the frequency of certain messages As a result, coaching feedback adjustment mechanism ensures that all audio feedback and messages are context appropriate and/or actionable to avoid potential annoyance from inappropriate or invalid coaching feedback.

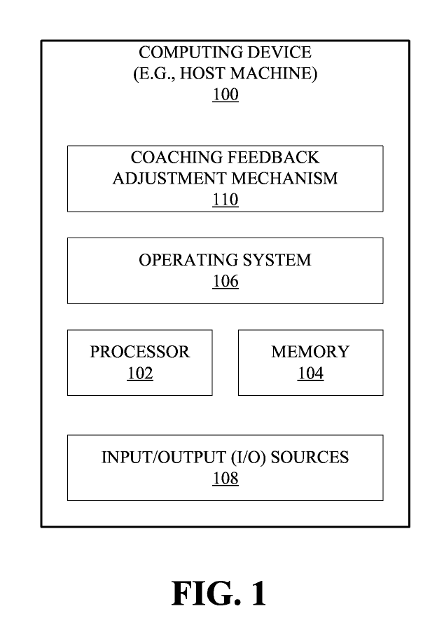

FIG. 1 illustrates one embodiment of a coaching feedback adjustment mechanism 110 at a computing device 100. In one embodiment, computing device 100 serves as a host machine for hosting coaching feedback adjustment mechanism (“feedback mechanism”) 110 that includes a combination of any number and type of components for athletic feedback at computing devices, such as computing device 100. In one embodiment, computing device 100 includes a wearable device. Thus, implementation of feedback mechanism 110 results in computing device 100 being an assistive device to provide effective audio feedback to a wearer of computing device 100.

In other embodiments, feedback operations may be performed at a computing device 100 including large computing systems, such as mobile computing devices, such as cellular phones including smartphones, personal digital assistants (PDAs), tablet computers, laptop computers (e.g., notebook, netbook, Ultrabook™, etc.), e-readers, etc. In yet other embodiments, computing device 100 may include server computers, desktop computers, etc., and may further include set-top boxes (e.g., Internet-based cable television set-top boxes, etc.), global positioning system (GPS)-based devices, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

Throughout this document, terms like “logic”, “component”, “module”, “framework”, “engine”, “point”, and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

It is contemplated that any number and type of components may be added to and/or removed from feedback mechanism 110 to facilitate various embodiments including adding, removing, and/or enhancing certain features. For brevity, clarity, and ease of understanding of feedback mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

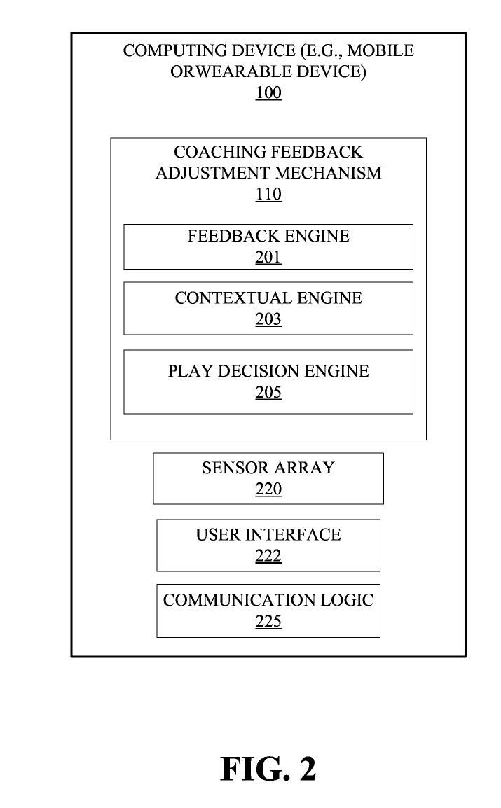

FIG. 2 illustrates a coaching feedback adjustment mechanism 110 employed at computing device 100. In one embodiment, coaching feedback adjustment mechanism 110 may include any number and type of components, such as: feedback engine 201, contextual engine 203, and play decision engine 205. It is contemplated that any number and type of components 201-205 of feedback mechanism 110 may not necessarily be at a single computing device and may be allocated among or distributed between any number and type of computing devices having (but are not limited to) server computing devices, cameras, PDAs, mobile phones (e.g., smartphones, tablet computers, etc.), personal computing devices (e.g., desktop devices, laptop computers, etc.), smart televisions, servers, wearable devices, media players, any smart computing devices, and so forth. Further examples include microprocessors, graphics processors or engines, microcontrollers, application specific integrated circuits (ASICs), and so forth. Embodiments, however, are not limited to these examples.

According to one embodiment, feedback engine 201 provides real-time feedback regarding performance, encouragement, acknowledgement or recognition of accomplishments. For example, feedback engine 201 may encourage an athlete halfway through, or at the last mile until the top of, a slope. Further, feedback module 201 may provide a strong recognition when the athlete reaches the top of the mountain. In one embodiment, feedback module 201 provides audio feedback via a user interface 222, which provides for user interaction with computing device 100.

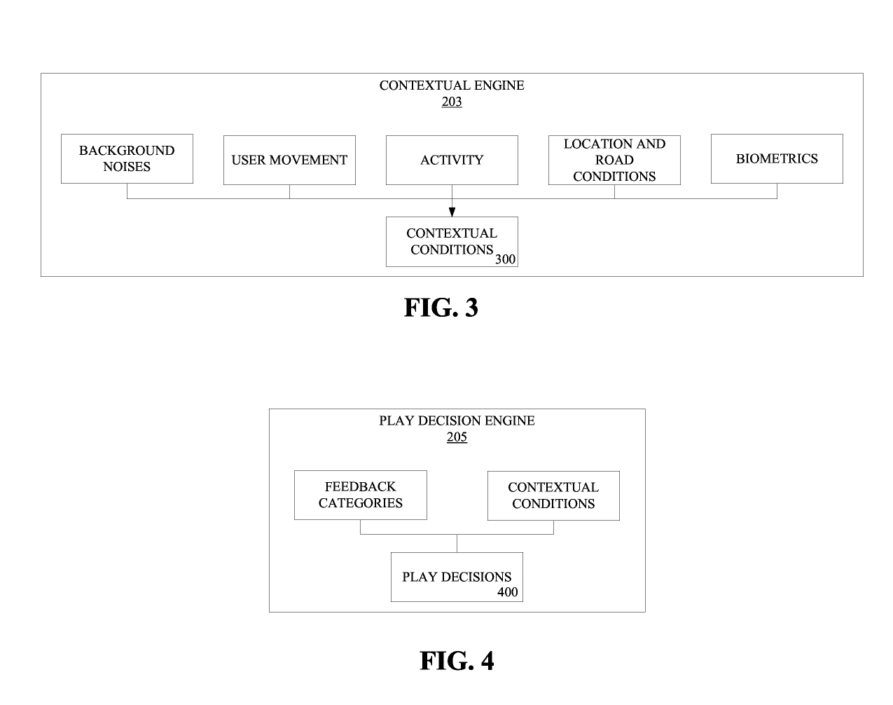

Contextual engine 203 provides context awareness for coaching feedback adjustment mechanism 110. In one embodiment, contextual engine 203 receives and analyzes data to determine user environment and activities. FIG. 3 illustrates one embodiment of contextual engine 203. As shown in FIG. 3, contextual engine 203 includes a contextual conditions module 300 that receives data regarding background noises, user movement (e.g., speed and up/down movement on a bumpy road), user activity (e.g., riding, running, walking, and stopping), location and road conditions and biometrics (e.g., heart rate and breathing). Contextual conditions module 300 identifies a contextual condition based on the received data. In one embodiment, contextual conditions include Normal, Cannot Hear, Cognitive Overload, Exertion of Effort, Temporary Exhaustion and Social Interaction.

In the Normal condition, a user is under a normal workout condition. Coaching feedback can be played without adjustment. In the Cannot Hear condition, background noise is too high for a user to hear anything. In the Cognitive Overload condition, contextual conditions module 300 uses information such as background noise, location, user speed, and movement, to determine that a user is in a situation in which it is necessary to pay close attention to road conditions, or expend great effort to control activity. Examples include: when a user is at traffic intersection or merging into a major thoroughfare, when the bike is making a sharp turn, a car is approaching from the behind, when a user is riding a bicycle with a very high speed or maneuvering a mountain bike over a very bumpy road, or when bike instability is detected.

In the Temporary Exhaustion condition, contextual conditions module 300 determines that a user has just finished a portion of very high intensity workout and is likely unable to digest any feedback before taking a quick recovery break. In one embodiment, temporary exhaustion is indicated by change of activity pattern (e.g., from high speed to low speed) and user biometrics such as an elevated heart rate and heavy breathing, or when a user has manually marked the end of high intensity interval period. In the Social Interaction condition contextual conditions module 300 detects from background noise that a user is having social interaction with another person.

In the Exertion of Effort condition, the contextual conditions module 300 determines that a user is making a big effort to reach certain goals, for example, to reach a certain speed, to climb over a steep slope.

In one embodiment, contextual engine 203 receives contextual data via sensor array 220. In such an embodiment, sensor array 220 includes context-aware sensors (e.g., myoelectric sensors, temperature sensors, facial expression and feature measurement sensors working with one or more cameras, environment sensors (such as to sense background colors, lights, etc.), biometric sensors (such as to detect fingerprints, facial points or features, etc.), and the like. According to one embodiment, sensors in sensor array 220 may be included in multiple wearable devices and transmit data (raw or analyzed) data to coaching feedback adjustment mechanism 110. In a further embodiment, sensor array 220 may include an acoustic microphone close to user's mouth such as in the frame of the glasses

Referring back to FIG. 2, play decision engine 205 makes decisions based on the contextual conditions received from contextual conditions module 300 and determines actions to be taken for different kinds of coaching feedback. In one embodiment, different classifications of coaching feedback may be implemented for different sports or applications. FIG. 4 illustrates one embodiment of play decision engine 205. Play decision engine 205 includes a play decisions module 400. In one embodiment, play decision module 400 selects from various feedback categories, including Regular Performance Update, Encouragement and Recognition, Mistake Correction, Starting of New Activities and Critical Notification.

Play decisions module 400 determines actions to be taken based on the contextual conditions and feedback categories. For example, decision scenarios include postponing all feedback during the Cannot Hear condition, until the contextual condition is cancelled, and postponing all feedback by 10 seconds during the Temporary Exhaustion condition. Another example includes postponing the Starting Of New Activities category whenever the Cognitive Overload condition occurs. Further, during this condition Critical Notification is played, Recognition and Encouragement and Mistake Correction are cancelled, and “Performance Update will be postponed until the contextual condition is cancelled or cancelled after waiting for more than 3 minutes. Yet another example occurs during the Social Interaction condition such as when a user is training with other people. In this condition, the user may still want to follow a specific training plan. Thus, play decisions module 400 will play Starting of New Activities and Mistake Correction, but suspend “Regular Performance Update and Encouragement and Recognition to reduce distraction for users. When Exertion of Effort is detected, adjustment may be made to increase or decrease the frequency of performance update, for example, to increase the frequency of heart rate and power output update for a cyclist, while reducing the frequency of update on distance and time.

Once play decision engine 205 makes a decision to play feedback, feedback engine 201 provides the feedback. Referring back to FIG. 2, communication logic 225 is also included within device 100. Communication logic 225 may be used to facilitate dynamic communication and compatibility between with various other computing devices (such as a mobile computing device, a desktop computer, a server computing device, etc.), storage devices, databases and/or data sources, such as database 240, networks (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), connectivity and location management techniques, software applications/websites), programming languages, etc., while ensuring compatibility with changing technologies, parameters, protocols, standards, etc.

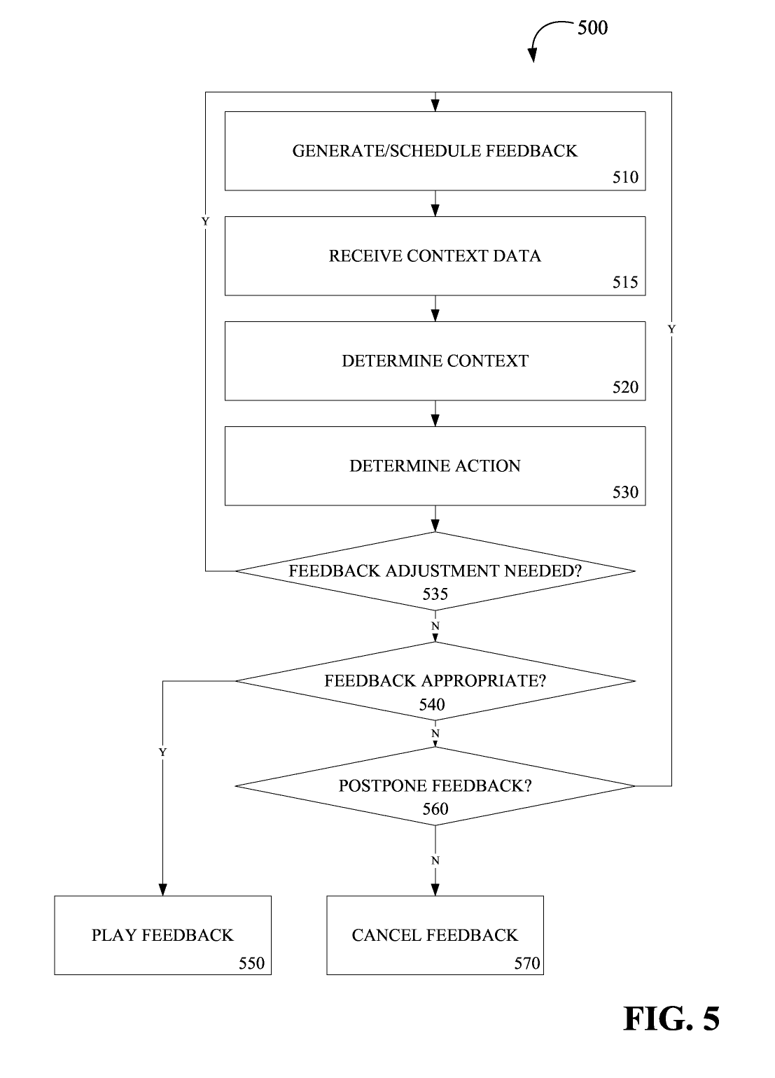

FIG. 5 is a flow diagram illustrating one embodiment of a process 500 performed by an coaching feedback adjustment mechanism. Process 500 may be performed by processing logic that may comprise hardware (e.g., circuitry, dedicated logic, programmable logic, etc.), software (such as instructions run on a processing device), or a combination thereof. In one embodiment, coaching feedback adjustment mechanism 110 may perform process 500. Process 500 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-4 may not be discussed or repeated here.

At processing block 510, feedback engine 201 generates and/or schedules feedback. At processing block 520, receives contextual data. At processing block 520, contextual engine determining a context based on received data. At processing block 530, play decision engine 205 determines one or more actions to take based on the context and feedback category. At decision block 535, a determination is made as to whether the feedback adjustment is needed. In one embodiment, feedback adjustment may include increasing/decreasing the frequency of certain performance feedback, or generating an alternative message.

If feedback adjustment is needed, control is returned to processing block 510, where the feedback is rescheduled with the needed adjustment. Otherwise, a determination is made as to whether it is appropriate to play the feedback, decision block 540. If so, feedback engine 201 plays the feedback, processing block 550. Otherwise, a determination is made as to whether to postpone the feedback, decision block 560. The feedback is cancelled if it is not to be postponed, processing block 570. If the feedback is to be postponed, control is returned to processing block 510 where it is rescheduled.

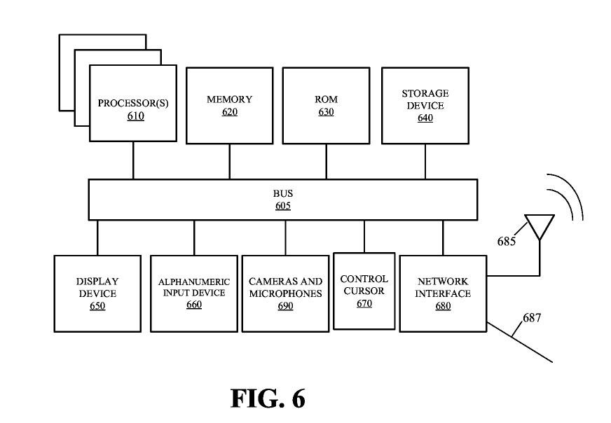

FIG. 6 illustrates a computer system suitable for implementing embodiments of the present disclosure. Computing system 600 includes bus 605 (or, for example, a link, an interconnect, or another type of communication device or interface to communicate information) and processor 610 coupled to bus 405 that may process information. While computing system 600 is illustrated with a single processor, electronic system 600 and may include multiple processors and/or co-processors, such as one or more of central processors, graphics processors, and physics processors, etc. Computing system 600 may further include random access memory (RAM) or other dynamic storage device 620 (referred to as main memory), coupled to bus 605 and may store information and instructions that may be executed by processor 610. Main memory 620 may also be used to store temporary variables or other intermediate information during execution of instructions by processor 610.

Computing system 600 may also include read only memory (ROM) and/or other storage device 630 coupled to bus 605 that may store static information and instructions for processor 610. Date storage device 640 may be coupled to bus 405 to store information and instructions. Date storage device 640, such as magnetic disk or optical disc and corresponding drive may be coupled to computing system 600.

Computing system 600 may also be coupled via bus 605 to display device 650, such as a cathode ray tube (CRT), liquid crystal display (LCD) or Organic Light Emitting Diode (OLED) array, to display information to a user. User input device 660, including alphanumeric and other keys, may be coupled to bus 605 to communicate information and command selections to processor 610. Another type of user input device 660 is cursor control 670, such as a mouse, a trackball, a touchscreen, a touchpad, or cursor direction keys to communicate direction information and command selections to processor 610 and to control cursor movement on display 650. Camera and microphone arrays 690 of computer system 600 may be coupled to bus 605 to observe gestures, record audio and video and to receive and transmit visual and audio commands

Computing system 600 may further include network interface(s) 680 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 680 may include, for example, a wireless network interface having antenna 685, which may represent one or more antenna(e). Network interface(s) 680 may also include, for example, a wired network interface to communicate with remote devices via network cable 687, which may be, for example, an Ethernet cable, a coaxial cable, a fiber optic cable, a serial cable, or a parallel cable.

Network interface(s) 680 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 680 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 680 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 600 may vary from implementation to implementation depending upon numerous factors, such as price constraints, performance requirements, technological improvements, or other circumstances. Examples of the electronic device or computer system 600 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable (or computer-readable) media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to an apparatus to facilitate coaching feedback adjustment comprising a sensor array to receive contextual data, a contextual engine to analyze the contextual data to identify contextual conditions based on user environment and activities indicated by the contextual data and a play decision engine to determine an action to be taken based on the identified contextual conditions.

Example 2 includes the subject matter of Example 1, further comprising a feedback engine to generate real-time feedback based on the action to be taken.

Example 3 includes the subject matter of Examples 1 and 2, wherein the contextual engine comprises a contextual conditions module to determine the contextual conditions from the contextual data.

Example 4 includes the subject matter of Examples 1-3, wherein the contextual conditions comprise at least one of Normal, Cannot Hear, Cognitive Overload, Temporary Exhaustion and Social Interaction conditions.

Example 5 includes the subject matter of Examples 1-4, wherein the contextual data comprises at least one of background noises, user movement, user activity, location, road conditions and biometrics.

Example 6 includes the subject matter of Examples 1-5, wherein the play decision engine comprises a play decisions module to determine the action to be taken based on the contextual conditions and feedback categories.

Example 7 includes the subject matter of Examples 1-6, wherein the feedback categories comprise at least one of Regular Performance Update, Encouragement and Recognition, Mistake Correction, Starting of New Activities and Critical Notification categories.

Example 8 includes the subject matter of Examples 1-7, further comprising a user interface provide audio feedback generated by the feedback engine.

Some embodiments pertain to Example 9 that includes a method to facilitate coaching feedback adjustment comprising generating feedback for a user, receiving contextual data at a sensor array, determining a context based on contextual conditions identified from the contextual data, determining an action to be taken based on the identified contextual conditions, determining whether the feedback is appropriate based on the action to be taken and the contextual conditions and playing the feedback upon a determination that the feedback is appropriate.

Example 10 includes the subject matter of Example 9, further comprising determining whether the feedback is to be postponed upon a determination that the feedback is not appropriate.

Example 11 includes the subject matter of Examples 9 and 10, further comprising cancelling the feedback upon a determination that the feedback is to not to be postponed.

Example 12 includes the subject matter of Examples 9-11, further comprising rescheduling the feedback.

Example 13 includes the subject matter of Examples 9-12, wherein rescheduling the feedback comprises adjusting the feedback to generate an alternative message or adjust a frequency of a message.

Example 14 includes the subject matter of Examples 9-13, wherein the contextual conditions comprise at least one of Normal, Cannot Hear, Cognitive Overload, Temporary Exhaustion and Social Interaction conditions.

Example 15 includes the subject matter of Examples 9-14, wherein the contextual data comprises at least one of background noises, user movement, user activity, location, road conditions and biometrics.

Example 16 includes the subject matter of Examples 9-15, further comprising determining an action to be taken based on feedback categories.

Example 17 includes the subject matter of Examples 9-16, wherein the feedback categories comprise at least one of Regular Performance Update, Encouragement and Recognition, Mistake Correction, Starting of New Activities and Critical Notification categories.

Some embodiments pertain to Example 18 that includes a wearable device comprising a sensor array to receive contextual data and a processor to execute a contextual engine to analyze the contextual data to identify contextual conditions based on user environment and activities indicated by the contextual data and a play decision engine to determine an action to be taken based on the identified contextual conditions.

Example 19 includes the subject matter of Example 18, wherein the processor further executes a feedback engine to generate real-time feedback based on the action to be taken.

Example 20 includes the subject matter of Examples 18 and 19, wherein the contextual engine comprises a contextual conditions module to determine the contextual conditions from the contextual data.

Example 21 includes the subject matter of Examples 18-20, wherein the play decision engine comprises a play decisions module to determine the action to be taken based on the contextual conditions and feedback categories.

Some embodiments pertain to Example 22 that includes at least one computer readable medium having instructions stored thereon, which when executed by a processor, cause the processor to perform the methods of claims 9-17.

Some embodiments pertain to Example 23 that includes at least one computer readable medium having instructions stored thereon, which when executed by a processor, cause the processor to generate feedback for a user, receive contextual data at a sensor array, determine a context based on contextual conditions identified from the contextual data, determine an action to be taken based on the identified contextual conditions, determine whether the feedback is appropriate based on the action to be taken and the contextual conditions and play the feedback upon a determination that the feedback is appropriate.

Example 24 includes the subject matter of Example 23, having instructions stored thereon, which when executed by a processor, further cause the processor to determine whether the feedback is to be postponed upon a determination that the feedback is not appropriate.

Example 25 includes the subject matter of Examples 23 and 24, having instructions stored thereon, which when executed by a processor, further cause the processor to cancel the feedback upon a determination that the feedback is to not to be postponed.

Example 26 includes the subject matter of Examples 23-25, having instructions stored thereon, which when executed by a processor, further cause the processor to reschedule the feedback upon a determination that the feedback is to be postponed.

Some embodiments pertain to Example 27 that includes an apparatus to facilitate coaching feedback adjustment comprising means for generating feedback for a user, means for receiving contextual data at a sensor array, means for determining a context based on contextual conditions identified from the contextual data, means for determining an action to be taken based on the identified contextual conditions, means for determining whether the feedback is appropriate based on the action to be taken and the contextual conditions and means for playing the feedback upon a determination that the feedback is appropriate.

Example 28 includes the subject matter of Example 27, further comprising means for determining whether the feedback is to be postponed upon a determination that the feedback is not appropriate.

Example 29 includes the subject matter of Examples 27 and 28, further comprising means for cancelling the feedback upon a determination that the feedback is to not to be postponed.

Example 30 includes the subject matter of Examples 27-30, further comprising means for rescheduling the feedback upon a determination that the feedback is to be postponed.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus to facilitate coaching feedback adjustment comprising:
a sensor array to receive contextual data;
a contextual engine to analyze the contextual data to identify contextual conditions based on user environment and activities indicated by the contextual data; and
a play decision engine to determine an action to be taken based on the identified contextual conditions.

2. The apparatus of claim 1, further comprising a feedback engine to generate real-time feedback based on the action to be taken.

3. The apparatus of claim 1, wherein the contextual engine comprises a contextual conditions module to determine the contextual conditions from the contextual data.

4. The apparatus of claim 3, wherein the contextual conditions comprise at least one of Normal, Cannot Hear, Cognitive Overload, Exertion of Effort, Temporary Exhaustion and Social Interaction conditions.

5. The apparatus of claim 3, wherein the contextual data comprises at least one of background noises, user movement, user activity, location, road conditions and biometrics.

6. The apparatus of claim 1, wherein the play decision engine comprises a play decisions module to determine the action to be taken based on the contextual conditions and feedback categories.

7. The apparatus of claim 6, wherein the feedback categories comprise at least one of Regular Performance Update, Encouragement and Recognition, Mistake Correction, Starting of New Activities and Critical Notification categories.

8. The apparatus of claim 1, further comprising a user interface provide audio feedback generated by the feedback engine.

9. A method to facilitate coaching feedback adjustment comprising:
generating feedback for a user;
receiving contextual data at a sensor array;
determining a context based on contextual conditions identified from the contextual data;
determining an action to be taken based on the identified contextual conditions;
determining whether the feedback is appropriate based on the action to be taken and the contextual conditions; and
playing the feedback upon a determination that the feedback is appropriate.

10. The method of claim 9, further comprising determining whether the feedback is to be postponed upon a determination that the feedback is not appropriate.

11. The method of claim 9, further comprising cancelling the feedback upon a determination that the feedback is to not to be postponed.

12. The method of claim 9, further comprising rescheduling the feedback.

13. The method of claim 9, wherein rescheduling the feedback comprises adjusting the feedback to generate an alternative message or adjust a frequency of a message.

14. The method of claim 9, wherein the contextual conditions comprise at least one of Normal, Cannot Hear, Cognitive Overload, Exertion of Effort, Temporary Exhaustion and Social Interaction conditions.

15. The method of claim 10, wherein the contextual data comprises at least one of background noises, user movement, user activity, location, road conditions and biometrics.

16. The method of claim 9, further comprising determining an action to be taken based on feedback categories.

17. The method of claim 16, wherein the feedback categories comprise at least one of Regular Performance Update, Encouragement and Recognition, Mistake Correction, Starting of New Activities and Critical Notification categories.

18. A wearable device comprising:
a sensor array to receive contextual data; and
a processor to execute:
a contextual engine to analyze the contextual data to identify contextual conditions based on user environment and activities indicated by the contextual data; and
a play decision engine to determine an action to be taken based on the identified contextual conditions.

19. The wearable device of claim 18, wherein the processor further executes a feedback engine to generate real-time feedback based on the action to be taken.

20. The wearable device of claim 18, wherein the contextual engine comprises a contextual conditions module to determine the contextual conditions from the contextual data.

21. The wearable device of claim 18, wherein the play decision engine comprises a play decisions module to determine the action to be taken based on the contextual conditions and feedback categories.

22. At least one computer readable medium having instructions stored thereon, which when executed by a processor, cause the processor to:
generate feedback for a user;
receive contextual data at a sensor array;
determine a context based on contextual conditions identified from the contextual data;
determine an action to be taken based on the identified contextual conditions;
determine whether the feedback is appropriate based on the action to be taken and the contextual conditions; and
play the feedback upon a determination that the feedback is appropriate.

23. The at least one computer readable medium of claim 22, having instructions stored thereon, which when executed by a processor, further cause the processor to determine whether the feedback is to be postponed upon a determination that the feedback is not appropriate.

24. The at least one computer readable medium of claim 22, having instructions stored thereon, which when executed by a processor, further cause the processor to cancel the feedback upon a determination that the feedback is to not to be postponed.

25. The at least one computer readable medium of claim 22, having instructions stored thereon, which when executed by a processor, further cause the processor to reschedule the feedback upon a determination that the feedback is to be postponed.
